(19) United States
(12) Patent Application Publication
(10) Pub. No.: US 2021/0321556 A1
(43) Pub. Date: Oct. 21, 2021

(54) BENT LEG OPENER FOR AN AGRICULTURAL SEEDING IMPLEMENT

(71) Applicant: Dutch Blacksmith Shop Ltd., Pilot Butte (CA)

(72) Inventor: Stuart Charles Stobbs, Pilot Butte (CA)

(21) Appl. No.: 16/901,221

(22) Filed: Jun. 15, 2020

Related U.S. Application Data
(60) Provisional application No. 63/013,100, filed on Apr. 21, 2020.

(51) Int. Cl. A01C 5/06

(52) U.S. Cl. CPC A01C 5/062

(57) ABSTRACT

An opener mounts on a tool supporting shank of an agricultural seeding implement for forming a furrow-type opening in the ground and delivering product into the ground as the agricultural seeding implement is displaced across the ground in a forward working direction. The opener includes a mounting body secured to the shank and a lower leg forming a knife that penetrates into the ground at an offset angle from vertical to minimize soil disturbance while seeding. The leading face of the lower leg and the front face of a lower portion of the mounting body each define a blunt edge (i) extending upwardly and rearwardly along a height thereof at a longitudinal slope, and (ii) extending in a widthwise direction across a majority of a width between the two side surfaces at a lateral slope that is between 60 degrees and 90 degrees from the forward working direction.

This application claims the benefit under 35 U.S.C. 119(e) of U.S. provisional application Ser. No. 63/013,100, filed Apr. 21, 2020.

### FIELD OF THE INVENTION

The present invention relates to an opener for mounting on a tool supporting shank of an agricultural seeding implement having a product delivery conduit associated with the tool supporting shank for forming a furrow-type opening in the ground and delivering product into the ground as the agricultural seeding implement is displaced across the ground in a forward working direction, and more particularly, the present invention relates to an opener in which a lower leg of the opener defines a knife that penetrates into the ground at an offset angle from vertical to minimize soil disturbance while seeding.

### BACKGROUND

Paraploughs are a tillage machine where the function is to reduce soil compaction by loosening the soil. These utilize a bent leg tine geometry to achieve a soil lifting action while eliminating the layers of soil mixing and soil throw present on standard vertical tined machines (subsoilers). A paraplough has no functionality for seeding as its operating depths are greater than standard seeding depths.

CNH Canada, Ltd. has patents and patent applications, for example U.S. Pat. No. 7,107,917, for a system similar to a paraplough tine where they reduced the size and incorporated product delivery tubes to the back side of the opener. This system has had several patent extensions filed but has never resulted in a known retail product. The description of the invention goes into great detail on how it has been optimized to reduce soil throw for minimum tillage while maintaining soil stratification. This is achieved by the wedged leading edge of the opener.

Daniel Rossouw developed the Blade RT in 2004 where he scaled down paraplough tines to a smaller version where it could be used as a seeding opener. The Blade RT has been studied at the University of South Australia by many individuals and most recently developed this into a high speed seeding opener. Soil throw has been minimized by using a bent leg opener among other aspects of studying soil mechanics. The opener that was built is a vertical opener with a 45 degree leg with a wedged leading edge.

The largest issue that both of the above noted openers have is they are slow to clear trash off of the shank and have poor seeding depth accuracy. Both of these issues stem from the single chamfered front face of the opener which results in 100% furrow back fill. With no soil moving up the shank to clear trash, the openers have a tendency to collect trash. The other aforementioned issue is seed placement, more specifically seeding depth, and how this issue changes is dependent on which type of drill it is being used.

On a conventional drill (air hoe drill or air seeder) the depth of the openers is set by the packers and/or the running gear attached to the frame. What this translates to is that an openers depth is determined several feet away from the point at which the seed is being placed. When an opener has a 100% back fill then the seeding depth then changes as the ground profile changes because there is no soil being displaced to create a furrow.

On an independent drill, an opener's depth is determined by the packer tire that is attached to the parallel linkage that the opener is mounted to. The same issue is present where if an opener has a 100% back fill, the depth of the opener is set by the ground contour that the packer tire is following. This will result in inaccurate seeding depth as any change in the grounds flatness translates into a change in seeding depth.

Another opener that has a similar appearance to a bent leg opener by CNH Canada, Ltd. is a double shoot opener described in U.S. Pat. No. 7,669,537. This opener is designed in such a way that from a main vertical body there are two wings protruding in a downwards angle in opposite directions of the body. Due to the length of the two wings to achieve an appropriate seeding depth the opener must be lowered into the ground to a point where the main vertical structure is below the surface level. With the ground entry angle being perpendicular relative to the axis that defines the width of the drill the soil throw is similar to a conventional opener where fractured soil is displaced horizontally by the main structure of the body.

### SUMMARY OF THE INVENTION

According to one aspect of the invention there is provided a bent leg opener for mounting on a tool supporting shank of an agricultural seeding implement having a product delivery conduit associated with the tool supporting shank for delivering product into ground across which the agricultural seeding implement is displaced in a forward working direction, the bent leg opener comprising:

a lower leg body adapted to be pulled through the ground in the forward working direction to form a product placement opening below a surface of the ground;

a mounting body having an upper portion adapted to be mounted onto the tool supporting shank and a lower portion extending downwardly from the upper portion so as to support the lower leg body in penetrating relation with the ground while the lower portion and the upper portion of the mounting body remain substantially above the ground;

a product delivery tube supported rearwardly of the mounting body so as to be arranged to deliver the product from the associated product delivery conduit of the implement to the product placement opening in the ground formed by the lower leg body;

the lower leg body defining a bent leg plane which is parallel to the forward working direction and which is sloped downwardly and lateral outwardly from the lower portion of the mounting body at a slope of between 30 degrees and 60 degrees from vertical;

the lower leg body having (i) two side surfaces at laterally opposing sides of the lower leg body, the side surfaces being oriented substantially parallel to the bent leg plane, and (ii) a leading face extending between the two side surfaces at a front of the lower leg body; and

the leading face defining a blunt edge that (i) extends in a lengthwise direction across a height of the lower leg body upwardly and rearwardly at a longitudinal slope that is between 30 degrees and 60 degrees from the forward working direction and (ii) extends in a widthwise direction between the two side surfaces at a lateral slope that is between 60 degrees and 90 degrees from the forward working direction.

The blunt leading edge described herein will increase soil throw marginally. This blunt leading edge shown in the illustrated embodiment is a surface where 50 percent of the face is oriented equal to or tangential to 30 degrees of being perpendicular to the 45 degree bent leg angle and the 50 degree rake angle. However, the bent leg angle and rake angles can range from 30 to 60 degrees. The material thickness of the bent leg portion is ½″ but can range from ⅜″ to 1″ in thickness. The product delivery tube that is directly behind the bent leg's width is double that of the maximum thickness of the bent leg but can range from the same thickness to the three times the thickness. All previous work has been on reducing soil disturbance to as little as possible regardless of the impact to other performance characteristics.

The issues of trash accumulation and seeding depth accuracy are both solved by controlling the amount of soil flow. A marginal increase in soil throw will improve trash clearance by using the thrown soil to remove the accumulation of straw from the shank.

A small increase in soil throw will also create a furrow which the packer tire will follow. This small amount of soil displaced horizontally will effectively smooth out the roughness of the ground to an average furrow profile and as a result the depth will be set from the averaged furrow profile.

The geometry of this opener has enabled the minimal amount of soil throw by having the main structure of the body enter the ground at a 45 degree angle from the axis along the drills width. This design feature creates a system where the majority of the soil that is in the fractured zone will not be interfered with by the opener's body. This allows the opener to pass through the soil with minimal horizontal soil displacement.

Another benefit of having a blunt leading edge is the increase in toughness when an obstacle is struck.

The advantages of this new minimalistic soil throw opener are most apparent when applied to an independent drill; more specifically, an implement such as a Paralink Hoe Drill (PHD) by Bourgault Industries Ltd., as described in U.S. Pat. No. 7,549,481, which uses a single product opener and MidRow Banders (MRB) to deliver seed and fertilizer separately. These drills' seed openers are a conventionally designed single shoot opener whose main structure that supports the tip is directly aligned with the tip in the direction of travel. This results in a maximum seeding speed because of stepping issues. By minimizing the soil movement while still maintaining drill functionality, seeding speed is potentially limited by the delivery of product, soil throw of the MRB's, available horsepower or the hydraulic system.

If minimal disturbance and speed are required a famer does have the option to purchase a disc drill which can already achieve these two characteristics. The drawback with disc drills is that they are an extremely high maintenance machine and inevitably an expensive machine to upkeep. A PHD has much fewer moving parts and requires very little maintenance when compared to a disc drill and so by equipping a PHD with a Bent Leg opener a farmer can achieve the speeds and minimal soil disturbance of a disc drill without the additional cost.

The mounting body may be arranged to support the lower leg body such that the lower leg body traverses a surface of the ground and such that the lower portion and the upper portion of the mounting body are spaced above the ground.

Preferably, the bent leg opener consists only of the lower leg body, the mounting body and the product delivery tube.

The longitudinal slope of the blunt edge at the leading face of the lower leg body may be between 35 degrees and 45 degrees from the forward working direction. More preferably, the longitudinal slope of the blunt edge at the leading face of the lower leg body is approximately 50 degrees from the forward working direction.

Preferably the blunt edge spans across at least 50% of an overall width of the leading face in the widthwise direction.

The blunt edge may span across a full width of the lower leg body in the widthwise direction between a first intersecting axis at an intersection of the leading face with a first one of the two side surfaces and a second intersecting axis at an intersection of the leading face with a second one of the two side surfaces, in which the lateral slope is defined within a plane containing both the first and second intersecting axes.

The blunt edge of the leading face of the lower leg body is preferably a flat surface.

Thickness of the lower leg body between the two side surfaces in proximity to the leading face is preferably between ⅜ of an inch and one inch.

The bent leg opener may further comprise: (i) the lower leg body including a forward portion extending rearwardly from the leading face and a rearward portion extending rearwardly from the forward portion at a location spaced rearwardly of the leading face; (ii) the rearward portion being increased in width between the two side surfaces relative to the forward portion so as to define a shoulder face that faces forwardly and that is in trailing relationship to the leading face at a location offset to one side of the leading face; and (iii) the shoulder face extending upwardly and rearwardly at a longitudinal slope that is between 30 degrees and 60 degrees from the forward working direction. The longitudinal slope of the shoulder face may be identical to the longitudinal slope of the leading face of the lower leg body. The shoulder face may extend in the widthwise direction at a lateral slope that is between 60 degrees and 90 degrees from the forward working direction. The rearward portion of the lower leg body may have a width between the two side surfaces of the lower leg body that is identical to a corresponding width of the product delivery tube.

The lower portion of the mounting body may include (i) two side surfaces at laterally opposing sides of the mounting body, and (ii) a front face extending between the two side surfaces at a front of the mounting body, and wherein the front face of the lower portion of the mounting body extends across a height of the lower portion of the mounting body upwardly and rearwardly at a longitudinal slope that is between 30 degrees and 60 degrees from the forward working direction. The longitudinal slope of the front face of the lower portion of the mounting body may be identical to the longitudinal slope of the leading face of the lower leg body. More particularly, the front face of the lower portion of the mounting body may be coplanar with the leading face of the lower leg body.

Alternatively, the longitudinal slope of the front face of the lower portion of the mounting body may be more vertical in orientation than the longitudinal slope of the leading face of the lower leg body.

In preferred embodiments, the front face of the lower portion of the mounting body defines a blunt edge that extends in a widthwise direction between the two side surfaces of the mounting body at a lateral slope that is 60 degrees and 90 degrees from the forward working direction.

### BRIEF DESCRIPTION OF THE DRAWINGS

One embodiment of the invention will now be described in conjunction with the accompanying drawings in which:

FIG. 1 is a perspective view of the bent leg opener;

FIG. 2 is a front elevational view of the bent leg opener;

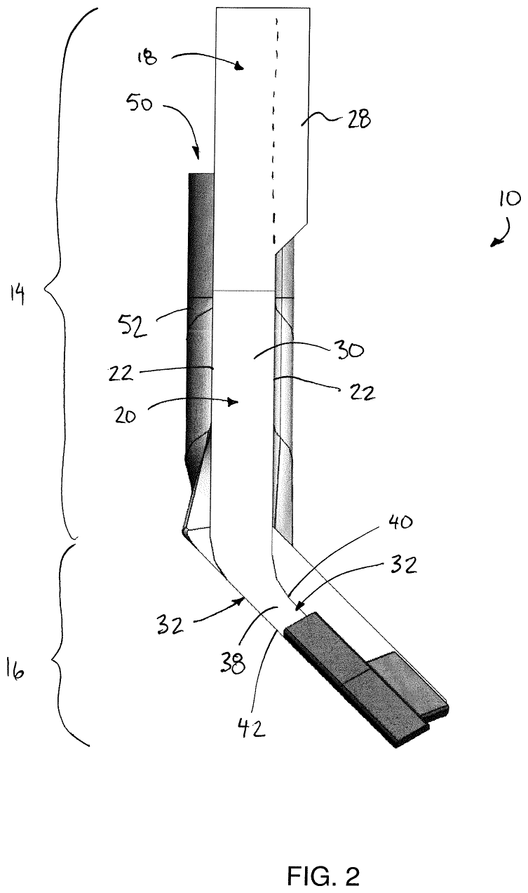

FIG. 3 is a top plan view of the bent leg opener;

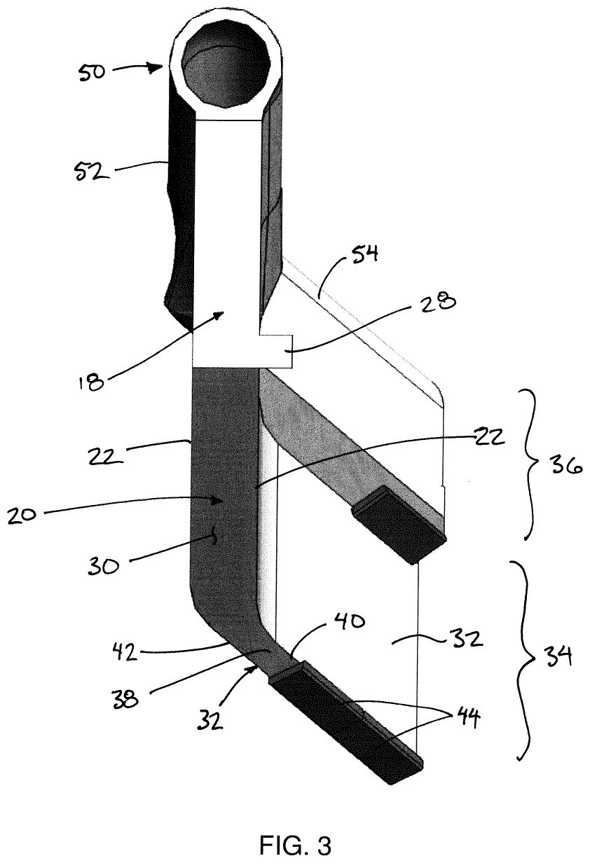

FIG. 4 is a right side elevational view of the bent leg opener;

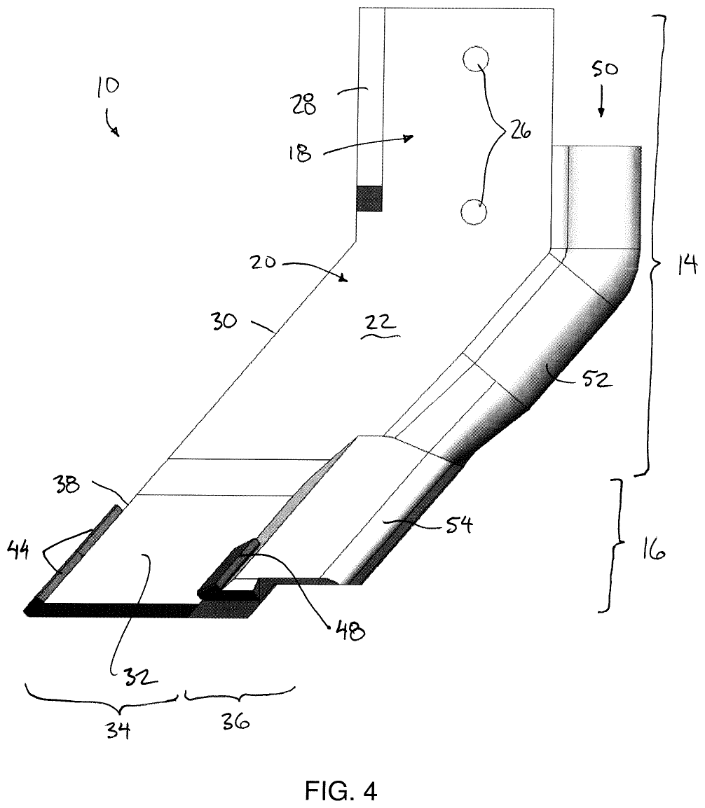

FIG. 5 is a left side elevational view of the bent leg opener;

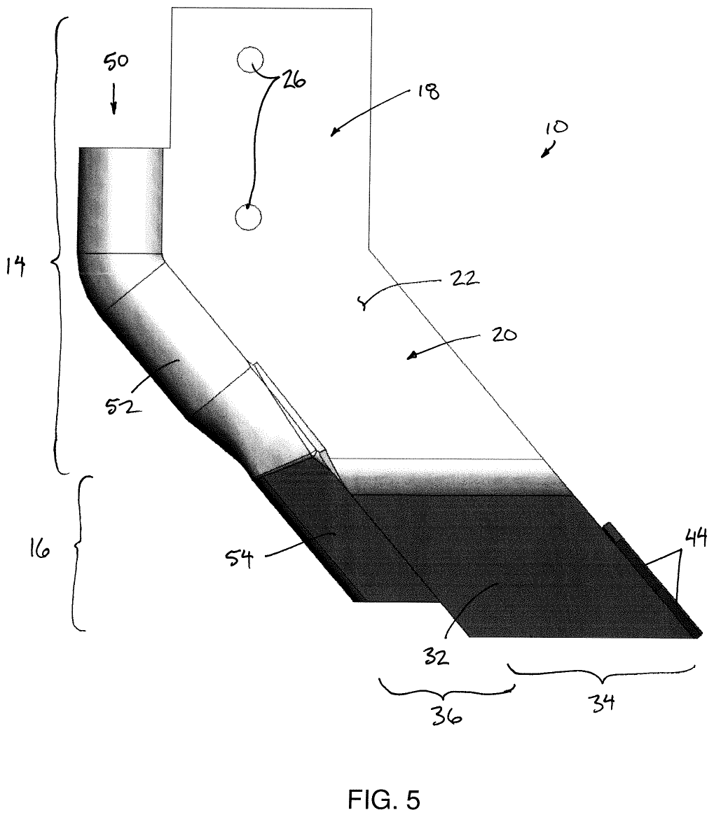

FIG. 6 is a rear elevational view of the bent leg opener; and

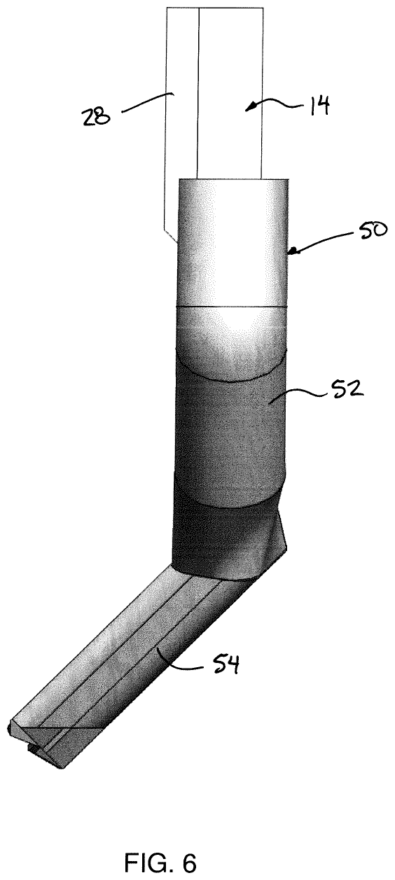

FIG. 7 is a bottom plan view of the bent leg opener.

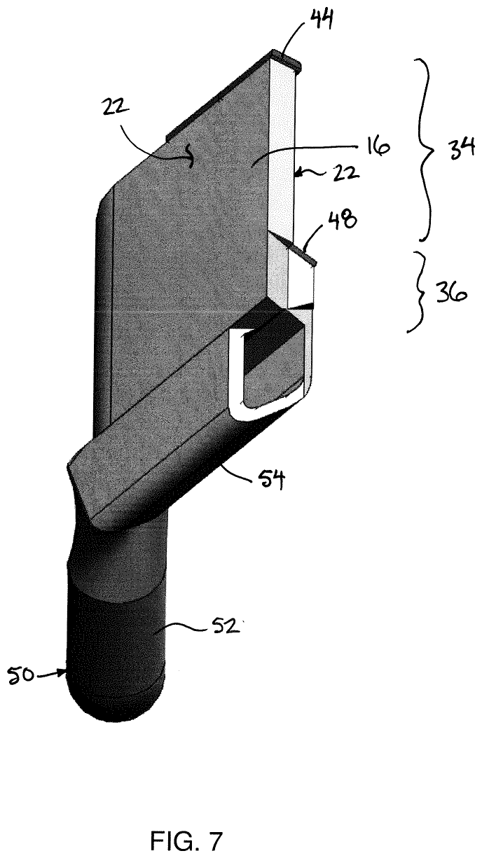

In the drawings like characters of reference indicate corresponding parts in the different figures.

### DETAILED DESCRIPTION

Referring to the accompanying figures, there is illustrated a bent leg opener generally indicated by reference numeral 10. The bent leg opener is adapted to be supported on an agricultural seeding implement (not shown) to be pulled through the ground in a forward working direction together with the implement to form a furrow in the ground in the form of a product placement opening below a surface of the ground.

A typical agricultural seeding implement includes a frame supporting a plurality of shanks 12 thereon which support respective ground working tools thereon. The frame includes a hitch for connection to a towing vehicle such as an agricultural tractor such that the ground working tools form furrows in the ground as the implement is displaced in a forward working direction together with the towing vehicle. A pneumatic seed delivery system includes a blower connected to pneumatic delivery lines and a metering system for metering seed from a seed supply into the pneumatic delivery lines. The delivery lines include manifolds that split the delivery lines into a plurality of delivery conduits such that one or more product delivery conduits is associated with each shank supporting a tool thereon.

The bent leg opener 10 described herein is particularly suited for use with an implement including a parallel link mounting arrangement (not shown) supporting each tool supporting shank on the frame of the implement according to U.S. Pat. No. 7,549,481 by Bourgault Industries Ltd. In this instance, a furrow opener bracket or shank is attached to the rear link of a parallel link assembly such that the furrow opener bracket and furrow opener attached thereto are maintained in a constant fore and aft angular orientation as the assembly moves up and down. A packer wheel arm is fixed to one of the upper and lower parallel arm members of the parallel link assembly, and extends rearward from the rear link, and a packer wheel is mounted to the packer wheel arm. A bias device exerts a downward force on the assembly. The presentation angle of the furrow opener with respect to the ground is maintained constant while the assembly moves up and down.

The opener 10 generally comprises a mounting body 14 arranged to be mounted on the tool supporting shank of the agricultural seeding implement while remaining above the surface of the ground in use, and a lower leg body 16 that extends below the mounting body at an offset angle from vertical and at an elevational such that the lower leg body traverses a surface of the ground in penetrating relation with the ground for forming a furrow-type opening in the ground with minimal soil disturbance of the ground while a top end of the lower leg body 16 that is connected to the mounting body remains at or spaced above the surface of the ground.

The mounting body 14 includes an upper portion 18 that connects to the implement via a shank 12, and a lower portion 20 extending downwardly from the upper portion below the elevation of the implement shank 12. The mounting body generally comprises a plate spanning both the upper portion 18 and lower portion 20 while defining a mounting plane that is vertical and parallel to the forward working direction. The plate forming the mounting body 14 has two side surfaces 22 which are parallel to the mounting plane and which are spaced apart from one another in a lateral direction of a lateral axis, the lateral axis being oriented horizontally and perpendicularly to the forward working direction.

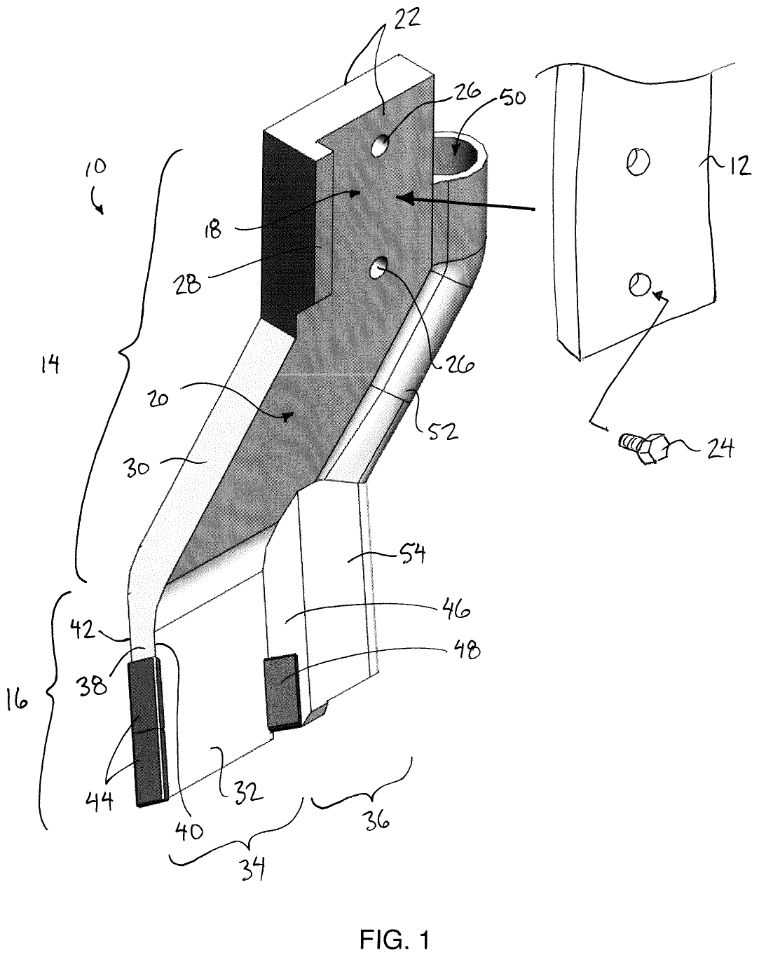

In the illustrated embodiment, the mounting body 14 is suited for mounting on a shank 12 in the form of a flat plate as shown in FIG. 1, which is vertical in orientation and parallel to the forward working direction. Two spaced apart mounting apertures extend in the lateral direction through the plate to receive fasteners 24 for fastening the opener to the shank.

In this instance, the upper portion 18 of the mounting body 14 is intended to be abutted against one side of the shank and is sized to span the depth of the shank 14 in the forward working direction while spanning a height of a lower mounting portion of the shank where the fastener mounting apertures are located. The upper portion 18 of the mounting body 14 includes a corresponding pair of mounting apertures 26 therein which are arranged to be aligned with the fastener mounting apertures in the shank respectively so that the fasteners 24 can fasten the opener to the shank.

The upper portion 18 further includes a front flange 28 which protrudes in a first lateral direction from a front edge of the plate forming the mounting body along a height of the upper portion 18 of the mounting body. The front flange 28 is vertically oriented and is perpendicular to the forward working direction so as to be suitable for abutment in overlapping arrangement along the front edge of the lower mounting portion of the implement shank 12. The flange 28 protrudes in the lateral direction from the corresponding side surface 22 of the mounting body by an overall thickness which is sufficient to fully span the lateral width of the shank 12.

The lower portion 20 of the mounting body extends continuously from the upper portion thereabove at a generally downward and forward slope. The lower portion is integral with the upper portion so as to be seamlessly joined as a unitary body of the same material. The two side surfaces 22 of the mounting body remain parallel to the forward working direction throughout the height of the lower portion while being coplanar with the respective portions of the side surfaces 22 in the upper portion 18 thereabove.

The lower portion defines a front face 30 which spans the height of the lower portion extending below the front flange 28 on the upper portion 18. The front face 30 spans in a widthwise direction laterally between the two side surfaces 22 such that the widthwise direction of the front face 30 is perpendicular to the forward working direction. In preferred embodiments the front face 30 comprises a blunt edge in which at least 50% of the surface across the width in the lateral direction is oriented near perpendicular or within 30° of the lateral axis. The blunt edge of the front face 30 spans the height of the lower portion 20 in a lengthwise direction of the front face so as to define a rake angle of approximately 40° from vertical, otherwise stated as 50° from the forward working direction. The longitudinal slope of the front face 30 extending in the lengthwise direction in preferred embodiments may range between 30 and 60° from the forward working direction.

The opener 10 further includes the lower leg body 16 as noted above, which extends continuously downward from the bottom end of the lower portion 20 of the mounting body thereabove. The lower leg body 16 is integral with the mounting body so as to be seamlessly joined as a unitary body of the same material. The lower leg body 16 is also primarily in the form of a plate of material in which the plate defines a bent leg plane that lies parallel to the forward working direction while being sloped downwardly and laterally outwardly at an offset angle of approximately 45° from vertical. In preferred embodiments the bent leg plane is oriented within the range of 30° to 60° from vertical while remaining parallel to the forward working direction.

The lower leg body 16 has two side surfaces 32 at laterally opposing sides of the lower leg body so as to be oriented generally parallel to the bent leg plane. The plate forming the lower leg body 16 generally includes a forward portion 34 at the front of the lower leg body, and a rearward portion 36 in trailing relationship with the forward portion 34 was to be located towards the rear of the lower leg body. The side surfaces 32 are spaced apart from one another in the lateral direction by a first thickness at the forward portion 34, while being spaced apart from one another in the lateral direction by a second thickness at the rearward portion 36 that is greater than the first thickness.

The lower leg body 16 further includes a leading face 38 that spans between the side surfaces 32 of the lower leg body at the forward portion 34 such that the width of the leading face in the lateral direction corresponds to the first thickness. More particularly the leading face 38 spans laterally in a widthwise direction from (i) a first intersecting axis 40 spanning the height of the lower leg body at the intersection of the leading face 38 with a first one of the side surfaces 32 to (ii) a second intersecting axis 42 spanning the height of the lower leg body at the intersection of the leading face 38 with a second one of the side surfaces 32. The leading face 38 also spans the full height in the lengthwise direction along the front of the lower leg body 16 between the bottom of the opener and a bottom of the front face 30 at the front side of the lower portion of the mounting body.

The leading face 38 defines a blunt edge illustrated in the accompanying figures as a single flat surface spanning the full width of the leading face 38 in the widthwise direction and the full height of the leading face 38 in the lengthwise direction. In further embodiments, the blunt edge preferably occupies at least 50% of the overall width of the leading face between the side surfaces 32 of the lower leg body along substantially the full height of the lower leg body.

In the illustrated embodiment, the blunt edge extends in the lengthwise direction as a compound angle including (i) a rake angle extending downwardly and forwardly at a longitudinal slope 50° from the forward axis and (ii) the offset angle of the bent leg plane extending downwardly and laterally outwardly at a bent leg angle of 45 degrees. The bent leg angle is measured as an angular offset from a vertical plane in the forward working direction. The longitudinal slope defining the rake angle in preferred embodiments may range between 60° and 90° from the forward working direction, as measured within a vertical plane oriented in the forward working direction.

In the illustrated embodiment, the longitudinal slope of the blunt edge is arranged such that the leading face 38 of the lower leg body is parallel and coplanar with the front face 30 of the mounting body.

In further embodiments however, the leading face 38 of the lower leg body and the front face 30 of the mounting body may be at different longitudinal slopes. For example, the leading face 38 may have a rake angle of 30 to 60 degrees from the forward working direction, while the face 30 has a rake angle of 60 to 90 degrees from the forward working direction so as to be steeper and more vertical than the leading face 38 which keeping the attack angle of the leading frame to maintain desirable soil movement characteristics.

The blunt edge portion of the leading face 38 is preferably oriented in the widthwise direction between the first intersecting axis 40 and the second intersecting axis 42 so as to be perpendicular to the forward working direction. In further embodiments, the blunt edge portion of the leading face 38 may be oriented in the widthwise direction within a range of 60 to 90° from the forward working direction, otherwise stated as less than 30° from the lateral axis.

The leading face 38 of the lower leg body further includes one or more wear inserts 44 integrally mounted thereon in which each wear insert comprises a wear resistant material, for example carbide, which is harder than the metal forming a remainder of the lower leg body and the mounting body of the opener. The wear insert is mounted in abutment onto the lower portion of the leading face 38 so as to form an integral part of the lower leg body.

The forward portion 34 of the lower leg body occupies a majority of the depth of the lower leg body extending rearward from the leading face 38 and defines the first thickness, preferably in the range between ⅜ of an inch and 1 inch. The rearward portion 36 is increased in thickness relative to the forward portion along the full height of the lower leg body at the rear end of the lower leg body. In the illustrated embodiment, the second thickness of the rearward portion is approximately double the first thickness and the first thickness is approximately ½ of an inch.

In the illustrated embodiment, the increased thickness of the rearward portion is offset to one side only relative to the forward portion corresponding to the upward facing side surface 32 of the lower leg body. In this manner a shoulder face 46 is defined at the leading edge of the rearward portion at the stepped profile between the first thickness of the forward portion and the second thickness of the rearward portion. The shoulder face 46 comprises a flat face defining a blunt edge extending in a lengthwise direction along the height of the lower leg body. The shoulder face also extends in a widthwise direction perpendicular to the lengthwise direction so as to extend laterally outwardly from the side surface 32 at the forward portion to the corresponding portion of the side surface 32 at the second portion. In the lengthwise direction, the shoulder face 46 extends as a longitudinal slope corresponding to the rake angle so to be oriented between 30° and 60° from the forward working direction along the height thereof and so as to be parallel to the longitudinal slope of the leading face 38 of the forward portion. In the widthwise direction, the shoulder face may be oriented at a slope ranging between 30° and 90° from the forward working direction, otherwise stated as less than 60 degrees from the lateral axis.

A wear insert 48 is also integrally mounted on the lower portion of the shoulder face 46 in which the wear insert comprises a wear resistant material, for example carbide, which is harder than the metal forming a remainder of the lower leg body and the mounting body of the opener.

The opener 10 further includes a product delivery tube 50 which is integrally formed with the lower leg body 16 and the mounting body 14 such that the product delivery tube is continuous, seamless and formed as a unitary body of the same material together with the lower leg body and the mounting body.

The product delivery tube 50 includes an upper portion 52 defining a circular product delivery passage there through such that the upper portion has an outer diameter which is greater than the lateral width of the mounting body 14 of the opener. The inner diameter of the passage corresponds approximately to the diameter of the associated product delivery conduit of the implement connected thereto in a mounted position. The upper portion 52 of the product delivery tube extends downwardly along the rear edge of the mounting body 14 across substantially the full height thereof while following the profile of the opposing front side of the mounting body. Accordingly the upper portion 52 extends vertically downwardly along the upper portion 18 of the mounting body while extending downwardly at a forward slope corresponding to the rake angle along the rear of the lower portion 20.

A lower portion 54 of the product delivery tube extends downward from the upper portion 52 along the rear edge of the lower leg body 16 to the bottom end of the opener. The lower portion similarly defines a product delivery passage therethrough but the passage in this instance includes a cross-section which is elongated in the forward working direction such that the external width of the lower portion 54 of the product delivery tube is reduced relative to the upper portion. More particularly, the lower portion 54 includes an external width in the lateral direction between opposing sides thereof which corresponds approximately to the second thickness of the rearward portion 36 of the lower leg body. The lower portion 54 of the product delivery tube follows the bent leg angle of the bent leg plane of the lower leg body and terminates at an open bottom end of the product delivery tube which is in proximity to but raised slightly upwardly from the bottom end of the lower leg body. A perimeter rim about the bottom opening of the product delivery tube lies in a substantially horizontal plane spaced upwardly from the bottom end of the opener while being positioned slightly laterally inwardly from the outermost edge of the lower leg body 16.

The opener 10 is mounted onto a respective shank 12 of an agricultural seeding implement and a respective product delivery conduit of the implement is connected to the open top end of the product delivery tube 50 rearward of the shank 12.

In use, as the implement is towed forwardly across the ground in the forward working direction, the mounting body 14 of the opener supports the lower leg body 16 in intersecting relation traversing across the upper surface of the ground such that the majority of the lower leg body is penetrated into the ground while the top end of the lower leg body connected to the bottom end of the mounting body 14 remains substantially at the surface of the ground or spaced above the surface of the ground. The portion of the opener body forming ground entry that traverses the surface of the ground thus corresponds to the lower leg body oriented at the bent leg angle from vertical so as to minimize soil disturbance at the entry of the opener into the ground. The bottom end of the lower leg body locating the bottom opening of the product delivery tube in proximity thereto is located downwardly and laterally offset relative to the entry of the opener at the surface of the ground so as to form a furrow-type opening or path or trail propagating through the ground with the opener in the forward working direction where seed can be deposited with minimal soil disturbance. The blunt edge along the lower leg body together with the rake angle thereof encourages a small degree of soil flow up the leading face of the lower leg body and the mounting body so that any trash encountered in the ground follows the soil flow up the leading face and away from the lower leg body.

Since various modifications can be made in my invention as herein above described, and many apparently widely different embodiments of same made, it is intended that all matter contained in the accompanying specification shall be interpreted as illustrative only and not in a limiting sense.

1. A bent leg opener for mounting on a tool supporting shank of an agricultural seeding implement having a product delivery conduit associated with the tool supporting shank for delivering product into ground across which the agricultural seeding implement is displaced in a forward working direction, the bent leg opener comprising:
a lower leg body adapted to be pulled through the ground in the forward working direction to form a product placement opening below a surface of the ground;
a mounting body having an upper portion adapted to be mounted onto the tool supporting shank and a lower portion extending downwardly from the upper portion so as to support the lower leg body in penetrating relation with the ground while the lower portion and the upper portion of the mounting body remain substantially above the ground;
a product delivery tube supported rearwardly of the mounting body so as to be arranged to deliver the product from the associated product delivery conduit of the implement to the product placement opening in the ground formed by the lower leg body;
the lower leg body defining a bent leg plane which is parallel to the forward working direction and which is sloped downwardly and lateral outwardly from the lower portion of the mounting body at a slope of between 30 degrees and 60 degrees from vertical;
the lower leg body having (i) two side surfaces at laterally opposing sides of the lower leg body, the side surfaces being oriented substantially parallel to the bent leg plane, and (ii) a leading face extending between the two side surfaces at a front of the lower leg body; and
the leading face defining a blunt edge that (i) extends in a lengthwise direction across a height of the lower leg body upwardly and rearwardly at a longitudinal slope that is between 30 degrees and 60 degrees from the forward working direction and (ii) extends in a widthwise direction between the two side surfaces at a lateral slope that is between 60 degrees and 90 degrees from the forward working direction.

2. The bent leg opener according to claim 1 wherein the mounting body is arranged to support the lower leg body such that the lower leg body traverses a surface of the ground and such that the lower portion and the upper portion of the mounting body are spaced above the ground.

3. The bent leg opener according to claim 1 wherein the bent leg opener consists only of the lower leg body, the mounting body and the product delivery tube.

4. The bent leg opener according to claim 1 wherein the longitudinal slope of the blunt edge at the leading face of the lower leg body is between 35 degrees and 45 degrees from the forward working direction.

5. The bent leg opener according to claim 1 wherein the longitudinal slope of the blunt edge at the leading face of the lower leg body is approximately 50 degrees from the forward working direction.

6. The bent leg opener according to claim 1 wherein the blunt edge spans across at least 50% of an overall width of the leading face in the widthwise direction.

7. The bent leg opener according to claim 1 wherein the blunt edge spans across a full width of the lower leg body in the widthwise direction between a first intersecting axis at an intersection of the leading face with a first one of the two side surfaces and a second intersecting axis at an intersection of the leading face with a second one of the two side surfaces, and wherein the lateral slope is defined within a plane containing both the first and second intersecting axes.

8. The bent leg opener according to claim 1 wherein the blunt edge of the leading face of the lower leg body is a flat surface.

9. The bent leg opener according to claim 1 wherein a thickness of the lower leg body between the two side surfaces in proximity to the leading face is between ⅜ of an inch and one inch.

10. The bent leg opener according to claim 1 further comprising:
the lower leg body including a forward portion extending rearwardly from the leading face and a rearward portion extending rearwardly from the forward portion at a location spaced rearwardly of the leading face;
the rearward portion being increased in width between the two side surfaces relative to the forward portion so as to define a shoulder face that faces forwardly and that is in trailing relationship to the leading face at a location offset to one side of the leading face;
the shoulder face extending upwardly and rearwardly at a longitudinal slope that is between 30 degrees and 60 degrees from the forward working direction.

11. The bent leg opener according to claim 10 wherein the longitudinal slope of the shoulder face is identical to the longitudinal slope of the leading face of the lower leg body.

12. The bent leg opener according to claim 10 wherein the shoulder face extends in the widthwise direction at a lateral slope that is between 60 degrees and 90 degrees from the forward working direction.

13. The bent leg opener according to claim 10 wherein the rearward portion of the lower leg body has a width between the two side surfaces of the lower leg body that is identical to a corresponding width of the product delivery tube.

14. The bent leg opener according to claim 1 wherein the lower portion of the mounting body includes (i) two side surfaces at laterally opposing sides of the mounting body and (ii) a front face extending between the two side surfaces at a front of the mounting body, and wherein the front face of the lower portion of the mounting body extends across a height of the lower portion of the mounting body upwardly and rearwardly at a longitudinal slope that is between 30 degrees and 60 degrees from the forward working direction.

15. The bent leg opener according to claim 14 wherein the longitudinal slope of the front face of the lower portion of the mounting body is identical to the longitudinal slope of the leading face of the lower leg body.

16. The bent leg opener according to claim 15 wherein the front face of the lower portion of the mounting body is coplanar with the leading face of the lower leg body.

17. The bent leg opener according to claim 14 wherein the longitudinal slope of the front face of the lower portion of the mounting body is more vertical in orientation than the longitudinal slope of the leading face of the lower leg body.

18. The bent leg opener according to claim 1 wherein the front face of the lower portion of the mounting body defines a blunt edge that extends in a widthwise direction between the two side surfaces of the mounting body at a lateral slope that is 60 degrees and 90 degrees from the forward working direction.
